(19) United States
(12) Patent Application Publication
(10) Pub. No.: US 2010/0159104 A1
(43) Pub. Date: Jun. 24, 2010

(54) METHOD FOR COOKING A STARCHY MATERIAL WITH A HIGH CONTENT OF DRY MATTER FOR THE PREPARATION OF AN ADHESIVE COMPOSITION

(75) Inventors: Christophe Bastien, La Madeleine (FR); Christian Bouxin, Marquillies (FR); Patrick Dauchy, La Couture (FR); Ludivine Onic, Beuvry (FR); Philippe Sabre, Saint Jans Cappel (FR)

Correspondence Address: YOUNG & THOMPSON, 209 Madison Street, Suite 500, Alexandria, VA, 22314, US

(73) Assignee: Roquette Freres, Lestrem (FR)

(21) Appl. No.: 12/293,549

(22) PCT Filed: Mar. 19, 2007
(86) PCT No.: PCT/FR07/00465

§ 371 Date: Sep. 19, 2008

(30) Foreign Application Priority Data
Mar. 21, 2006 (FR) 0602451

(51) Int. Cl. A23L 1/0522

(52) U.S. Cl. 426/578

(57) ABSTRACT

A method for cooking a starchy composition, includes: (a) a first step of mixing at least one starch powder with an aqueous starch fluid, wherein the ratio of the mixture of the starch powder to the aqueous starch fluid is such that the total starch content of the mixture obtained is greater than 45% by weight, and wherein the first step is carried out in a cooking chamber maintained at a temperature at least equal to the highest gelatinization temperature (GT) of all the starches present in the mixture, for a period of time sufficient to obtain a colloidal solution of starch, and (b) a second step comprising heating the colloidal solution of starch obtained in step (a), at a pressure greater than atmospheric pressure and at a temperature of between 120° C. and 180° C.

The present invention relates to a continuous or discontinuous method for cooking a starchy material with a high content of dry matter, the starchy compositions thus obtained and their use, in particular as adhesives.

The purpose of the present invention is to propose a relatively simple and inexpensive cooking method, making it possible to cook liquid starchy aqueous compositions with a high content of dry matter. This method must make it possible to obtain aqueous starch solutions, essentially free from granular starch, having both a high content of dry matter, greater than 35% by weight and preferably less than 75% by weight, a sufficiently low viscosity to allow their easy use in paper manufacturing plants and adhesive plants, and good storage stability, in other words, starchy compositions which, after cooling, do not exhibit any retrogradation phenomena (gelification by recombination of the amylose macromolecules).

Various devices and methods for the continuous production of starchy glues presented in the form of colloidal solutions, in particular with a high content of dry matter, have already been the subject of publications.

There can be mentioned European patent application EP 0 096 935, which discloses a method for preparing, in particular continuously, an adhesive composition, which consists of subjecting a mixture of water and granular starch to a mechanical processing, repeated by recycling. The shearing and heating produced by friction, generally limited to a temperature below 90° C., make it possible to obtain a colloidal solution of starch within the context of a method which is however not suitable for the production of glues with high concentrations of starchy materials. In fact, only concentrations comprised between and 30% are mentioned, and the examples illustrate compositions having a dry matter content of the order of only 11 to 12%.

Various patents filed in the United States propose simple means for mixing powders and liquids, involving neither thermal gain, nor recycling. These are for example U.S. Pat. No. 4,201,485, U.S. Pat. No. 4,323,314 and U.S. Pat. No. 4,444,508, which describe various ways of carrying out the continuous mixing of liquids and powders, under high or even very high shear forces.

These documents do not mention starches. They do not provide any heating means.

In European patent application EP 1 609 834, it is proposed to form an aqueous adhesive composition at a high or low temperature, from polymers chosen from a wide range, having dry matter contents comprised within a vast range, from 0.5 to 80%, in a high shear rate mixing unit. This application which describes a method for the preparation of a colloidal solution having an optionally high content of dry matter, stresses the requirement for several passages through a mechanical system at a high shear rate, which is known to be very expensive. The Applicant considers that such a system, which is singularly expensive and complex, is too difficult to implement on an industrial scale.

In the field of gluing corrugated cardboard, the European patent application EP 0 051 883 relates to heterogeneous preparations, comprising a primary part, of gelatinized starchy material in the form of colloidal solution, and a secondary part, of granular starch. Only the primary part is subjected to moderate heating before mixing of the two parts. A so-called secondary part of the starch remains in the granular state. This document does not therefore deal with the technical problem of obtaining colloidal solutions, essentially free from granular starch, having high contents of dry matter, greater than 35% by weight.

The Japanese patent application JP 05 320597 recommends the use of a “Jet Cooker” type of equipment, well known to a person skilled in the art, for the cooking at a high temperature (150° C.) of an aqueous suspension of starch. Granular starch is then added to the solution of gelatinized starch so as to bring the total starch content of the starchy adhesive composition to a value greater than or equal to 30% by weight. As a result these adhesives contain a significant fraction of insoluble granular starch.

The same applies to the European patent applications EP 0 229 741 and EP 0 376 301 which relate to the preparation of adhesive compositions intended for gluing corrugated cardboard, comprising a primary part containing soluble starch and a secondary part containing granular starch, only the primary part being treated at a high temperature.

The Applicant is interested in such adhesive compositions and their continuous preparation. The French patent application FR 2 283 937 and the U.S. Pat. No. 4,917,870 illustrate the benefit that it brings to this type of preparation.

The French patent FR 2 149 640, filed by the Applicant, constitutes a first response to the technical problem of obtaining compositions with a high soluble starch content, even if the latter is only partial. This document discloses a method for the preparation of starch pastes having a dry matter content which can reach 70%, by enzymatic degradation of native or chemically modified starch.

The quality of the colloidal solutions obtained according to this method however is generally not sufficient to be of interest to a person skilled in the art. In particular, the rheological and adhesive properties, obtained with the starches of cereals and legumes, are insufficient. The processing of starches from esterified or etherified tubers is the only one, in reality, to exhibit a certain benefit.

Thus a need still exists for a method making it possible to reconcile the following requirements:
mechanically simple and inexpensive equipment,
reliable operation requiring little energy,
possibility of treating all types of starches whether these are starches of tubers, cereals or legumes,
obtaining compositions having high contents of dry matter, greater than 35% by weight, allowing substantial energy savings during the drying of these compositions,
obtaining compositions having satisfactory adhesive and rheological properties, in particular a Brookfield viscosity preferably not exceeding 6000 centipoises (at 25° C.), and an ability to form a film.

It is thus to the Applicant's credit that, after time-consuming work, he has been able to determine that it was possible of arrive at the sought ends by implementing a method in two stages:
a first stage of mixing/gelification involving mixing, at atmospheric pressure and under sufficient stirring to avoid the formation of lumps, a starch powder and an aqueous slurry already containing a certain quantity of starch while heating at a temperature and for a period sufficient to initiate the gelification of the starch in suspension, and a second stage of heating the colloidal solution thus obtained at a temperature above 120° C., impossible to implement at atmospheric pressure. This second stage of heating at a high temperature results, at the molecular level, in the complete gelatinization of the starch, in the breaking of the intermolecular hydrogen bonds and in the dissolution of the macromolecules. The starch solutions thus obtained are characterized by a relatively low viscosity considering their high dry matter contents, and by excellent stability. In fact, no phenomenon of gelification by re-establishment of the intermolecular bonds between the starch chains is observed and the viscosity of the cooled solutions increases little over time.

Each of the two stages of the method has a specific role: the first, thanks to stirring means which are both simple and effective, and can be utilized at atmospheric pressure, serves to prepare a partially gelatinized colloidal solution, with a high dry matter content, which is free of lumps; the second stage implemented under pressure and with stirring means which can be less effective than those used in the first stage, serves to complete the gelatinization, i.e. to achieve the breaking of all of the hydrogen bonds and the complete dissolution of the starch molecules.

A subject of the present invention is thus a method for cooking a starchy composition comprising:

(a) a first stage comprising the mixing of at least one starch powder with an aqueous starch slurry containing granular starch and/or gelatinized starch, the starch content of the aqueous starch slurry and the mixing ratio of the starch powder to the aqueous starch slurry being such that the total starch content of the mixture obtained is greater than 45% by weight, preferably comprised between 50 and 82% by weight, and in particular comprised between 52% and 75% by weight, said first stage being carried out at atmospheric pressure, under stirring, in a cooking chamber maintained at a temperature at least equal to the highest gelatinization temperature (TG) of all of the starches present in the mixture, preferably at a temperature greater than or equal to 85° C., for a time sufficient to obtain a colloidal solution of starch, and
(b) a second stage comprising the heating of the colloidal solution of starch obtained in stage (a), at a pressure above atmospheric pressure and at a temperature comprised between 120° C. and 180° C., preferably comprised between 140° C. and 180° C. for a period sufficient to destroy the intermolecular hydrogen bonds and avoid the retrogradation of the starch solution obtained after cooling down.

By “gelatinization temperature” in the present application the temperature at which a BRABENDER viscograph, adjusted for a rise in temperature of 1.5° C. per minute, records for a suspension of granular starch in water a difference in viscosity of 20 units relative to the base line.

By “starch powder” is meant the starchy material in the granular state, i.e. insoluble in water. This powder flows freely and is free from any risk of agglomeration (“caking”) which could be detrimental to the evenness of its distribution in the aqueous slurry.

The starch powder introduced into the cooking chamber in stage (a) advantageously has a moisture content of less than 50%, preferably comprised between 3 and 30%, in particular comprised between 7 and 22%.

The aqueous slurry can be a “starch milk”, i.e. a suspension of insoluble granular starch in water. When it is a starch milk, the latter advantageously has a dry matter content of less than 52%, preferably comprised between 20 and 50%, in particular comprised between 30 and 45% by weight.

The aqueous starch slurry can also be a colloidal solution, i.e. a solution containing starch in dissolved form. This solution advantageously has a starch content of less than 75%, preferably comprised between 35 and 70%, and in particular comprised between 38 and 65% by weight.

In an advantageous embodiment of the method of the invention the aqueous starch slurry is formed by the colloidal solution of starch obtained at the end of stage (b), part of which is recycled to stage (a).

The starch powder and the starch in the aqueous starch slurry, whether in granular or gelatinized form, are chosen independently from the starches of tubers, the starches of cereals and the starches of legumes.

These starches can be native starches or modified starches.

They can be, in particular, chemically modified starches such as starches which are oxidized, esterified, etherified, crosslinked and/or hydrolyzed by any chemical or enzymatic means, or also starches modified by thermomechanical means such as extrusion, or by thermal means such as so-called “annealing” or “Hot Moisture Treatment” (HMT) operations.

Preferably the starch powder and the starch in the aqueous starch slurry are of the same origin.

The temperature at which stage (a) is implemented in the cooking chamber is advantageously at least 5° C. higher than the gelatinization temperature of the starch which has the highest gelatinization temperature out of all of the starches present in the mixture. It is preferably at least 10° C. above the highest gelatinization temperature of all of the starches present in the mixture. As explained above, the first stage in the cooking chamber serves to obtain a colloidal solution containing starch almost all of which is gelatinized, i.e. swollen with water. This colloidal solution, obtained at the end of stage (a) can however contain a relatively small fraction of granular starch and imperfectly gelatinized starch. The duration of stage (a) necessary in order to obtain a satisfactory gelatinization is of course all the shorter, the higher the heating temperature.

It is generally comprised between 3 minutes and 2 hours, preferably between 5 minutes and 1 hour and in particular between 10 and 30 minutes.

The aqueous starch slurry can in principle be introduced into the cooking chamber at ambient temperature, but it is preferable to preheat it. When the aqueous starch slurry is a colloidal solution of starch, it is preferably heated at a temperature comprised between 100° C. and 180° C. before being introduced into the cooking chamber of stage (a).

According to a variant of the method of the invention, two aqueous starch slurries are used, one in the form of starch milk, the other in the form of a colloidal solution of at least one starch, as defined previously.

The second stage of the method of the present invention is intended to complete the gelatinization, to break the hydrogen bonds of the gelatinized starch and to dissolve the starch in the aqueous medium, i.e. to obtain a dispersion on a molecular scale of the macromolecular chains in order to obtain starchy compositions having both a high dry matter content and a moderate viscosity, namely a Brookfield viscosity, measured at 25° C. and at 100 rpm, of less than 6000 centipoises, preferably less than 5000 centipoises and in particular less than 4000 centipoises.

The duration of heating in stage (b), sufficient to obtain such starch solutions essentially free of granular starch and having the above viscosities is generally comprised between 15 seconds and 30 minutes, preferably between 20 seconds and 15 minutes and in particular between 30 seconds and 10 minutes.

According to a preferred embodiment of the method according to the invention the heating at stage (b) is carried out by the injection of steam under pressure into the colloidal solution of starch obtained at the end of stage (a). The implementation of such a steam injection is described in more detail hereafter, with the aid of the figures.

The cooking of the starchy material can be carried out in the presence of at least one additive chosen from the additives commonly used in the industries concerned.

It can thus be useful, depending on the materials treated and the objectives aimed at, in particular in terms of the sought final concentration, to add to the cooking chamber of stage (a), one or more of the following ingredients:
plasticizers chosen, in particular, from urea, sorbitol, glycerin, optionally hydrogenated glucose syrups, sodium nitrate,
stabilizers such as stearates, in particular magnesium stearate,
pH adjusting and fixing agents such as sodium carbonate,
swelling retarding agents chosen in particular from phosphates, sodium sulphate, citrate and chloride,
mineral or organic, fillers or pigments, chosen in particular from the kaolins, calcium carbonates, precipitated or natural, calcium sulphates, talc or titanium oxides,
fluidifying agents of the starch powders, such as colloidal silicas,
enzymes chosen in particular from α-amylases, CGTases or so-called branching enzymes,
agents increasing the viscosity of the colloidal starch solutions such as borax or aluminium sulphate,
additives conferring particular properties on paper, in particular those intended to improve the optical and mechanical properties of the paper.

A subject of the present invention is also the starchy compositions which can be obtained by the method of the present invention. These compositions differ from those of the state of the art by their significant dry matter content, greater than or equal to 35% by weight, the absence of granular starch, a moderate flow viscosity and good resistance to retrogradation.

The starchy compositions of the present invention preferably have a total starch content of less than 75%, preferably comprised between 35 and 70%, in particular comprised between 38 and 65% by weight.

Thanks to its high, or even very high, content of dry extracts, the drying of a film obtained from such compositions is easy and requires little energy. The material savings are substantial.

Furthermore, the compositions, which have a dry extract content greater than or equal to 50%, make it possible for a person skilled in the art to envisage the replacement of solutions or emulsions of synthetic polymers.

The method according to the invention can be implemented on a cooking device comprising:

(a) a cooking chamber equipped

with means for ensuring the introduction of a starch powder,
with stirring means,
with means for introducing an aqueous starch slurry comprising water, granular starch and/or gelatinized starch, preferably at a point situated as close as possible to said powder feed, and
with means making it possible to maintain a cooking temperature at least equal to 85° C. in the cooking chamber
   (b) means for continuously taking samples of a colloidal solution at the cooking chamber outlet, and
   (c) means making it possible to subject the colloidal solution taken from the cooking chamber outlet to the action of steam having a temperature comprised between 120° C. and 180° C.

The device can moreover comprise means making it possible to adjust the rate of introduction of the starch powder and the aqueous granular starch slurry.

The characteristics and advantages of the invention will become clearly apparent on reading the detailed description which follows, of one of its embodiments, made with reference to the attached drawings in which

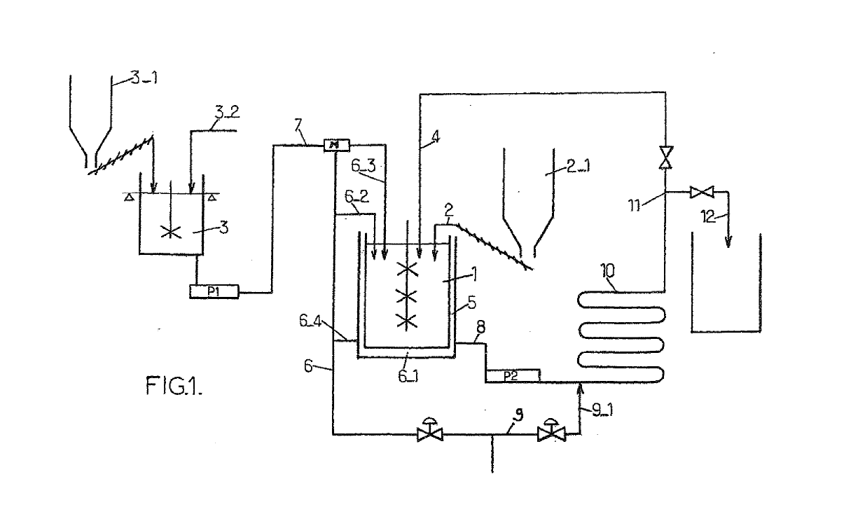

FIG. 1 corresponds to the general diagram of a device making it possible to implement the method according to the invention.

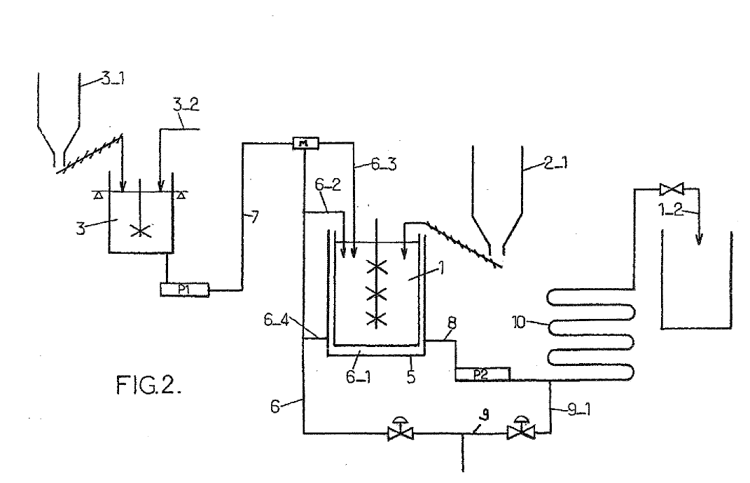

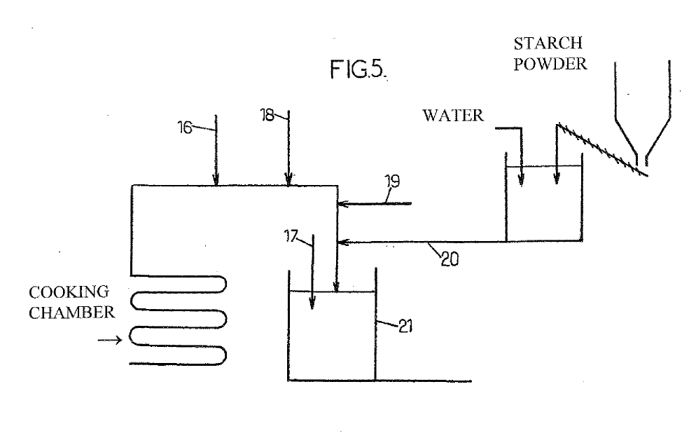

FIGS. 2 to 5 show variants of this device. In these figures, P represents a pump, M a mixer and H a hydrocyclone.

Such a device comprises:
on the one hand, a cooking chamber 1 equipped with means suitable for ensuring the introduction of the starch powder 2, aqueous granular starch slurry 1, supplied, in particular, by continuous volumetric dosage, preferred for its lower cost, or by continuous weighing by means of a weighing screw, and/or aqueous slurry which is a colloidal solution of starch 4, and
on the other hand, means for ensuring the necessary heat supply, in particular in the form of steam provided under pressure, at a temperature generally comprised between 120 and 180° C.

In order to heat the chamber 1 in which the first stage of cooking is implemented, it is possible to install a vat 5 which is double-walled, with a space (6-1) in which steam is circulated, preferably at a temperature comprised between 120 and 180° C., preferably at least equal to 140° C., in particular at least equal to 150° C. or optionally, a hot oil.

Another advantageous means consists of the introduction of previously heated water into a water/steam exchanger or by direct injection of steam into the cooking chamber, in particular at atmospheric pressure (6-2), this choice possibly having the additional and not insignificant benefit of involving the hot water, liquid or steam in the dispersion of the powder starch.

This variant can also make it possible to avoid the supply of steam at the base of the chamber (6-4) and thus to eliminate risks of induced vibrations or clogging of the steam distribution ring.

The steam which is useful for heating by direct injection can also be supplied and mixed in the fluid carrying granular starch milk 7, said steam bringing it, in the present case, to the colloidal solution state at (6-3).

These various means correspond to as many possibilities as are offered by the device. They can also be combined.

The heat input, via the double wall and/or injection of steam, ensures the maintenance, in the chamber, of the temperature necessary for cooking all of the starch, the latter thus being at least equal to the gelatinization temperature of the starch having the highest gelatinization temperature.

The granular starch milk is obtained in a preparation vat 3, which is supplied with granular starch powder via the reservoir (3-1) and via a water pipe (3-2).

The granular starch is supplied in powder form from the reservoir (2-1), by means of the distributor 2, as far as the cooking chamber 1. The residence time of the granular starch in said chamber 1 is that necessary for the desired solubilization. It depends on the volume of the chamber, the different feed flow rates, in particular that of the starch and the carrier fluids, and, of course, on the pumping speed at the outlet.

The colloidal starch solution is continuously removed at the outlet, generally at the base of the chamber, at 8. It is then directed towards a heat treatment section, which is sufficiently insulated, making it possible to subject the colloidal solution, at (9-1), to an injection of live steam 9.

The heat treatment section is particularly advantageously, coil-shaped piping 10, inside which the colloidal solution is subjected to the action of steam the temperature of which is comprised between 120 and 180°.

A pump with a high shear rate can be combined with the injection of steam and just after it. It provides the double advantage of significant shear and easier production of sufficient pressure in the coil.

The coil 10 and the injection device (9-1) can take any other geometrical shape, once the thermal and mechanical effect of the steam is ensured.

The heat input provided at the level of this device, can be carried out by any suitable means, for example by an oil bath.

Between the base of the chamber 8 and the point of injection of live steam 9, it can be useful to install complementary mechanical means such that, for example, “GYROFLUX” type equipment marketed by the company “VMI/Rayneri”, a high shear pump and/or a pump of the “rotor and counter-rotor” type.

These materials are intended to complete, by the intense mechanical action, the states of cooking and/or rheological behaviour and, in particular, to reduce the viscosity of the colloidal solution, without any appreciable, and overall, modification of the molecular mass of the starch.

At the outlet from the coil, a three-way valve type device 11 makes it possible to separate two flows, the first directed towards use on the machine 12, the other being intended to be recycled and to constitute a carrier fluid being presented in the form of colloidal solution 4.

This recycled flow can be subjected to the action of a high shear pump, of a “GYROFLUX” type system and/or “rotor and counter-rotor” type equipment.

According to a first variant, also shown in FIG. 1, the added portion of steam 6, intended for the cooking chamber 1, can be partially or totally supplied via the bottom of the vat 5, at (6-4), in particular via a distributor ring.

FIG. 2 shows a variant of a device using only granular starch milks as aqueous starch slurries. All of the colloidal solution produced at the end of stage (b) is directed towards direct utilization.

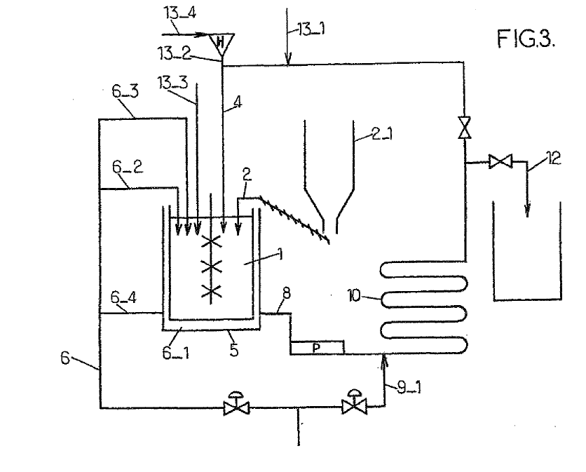

By contrast, the device shown in FIG. 3 operates without a supply of granular starch milk and uses only a colloidal solution recycled from stage (b). The circuit then achieves satisfactory operation by a judicious sharing of the colloidal solution produced between direct utilization and partial recycling towards the cooking chamber. Equilibrium can be achieved, in particular, by means of a supply, even limited, of steam via the pipe 6, whether at (6-1), (6-2), (6-3) and/or (6-4), even in the case of the operation stopping.

However, in the majority of the cases corresponding to such diagrams, a supply of water in the circuit is then necessary. The desired dilution can then be obtained by the introduction of water into the partial recycling of the glue (13-1—FIG. 3), by mixture of the colloidal solution and water (13-4—FIG. 3) at the level of a hydrocyclone (13-2—FIG. 3) and/or by the addition of water to the cooking chamber itself (13-3—FIG. 3).

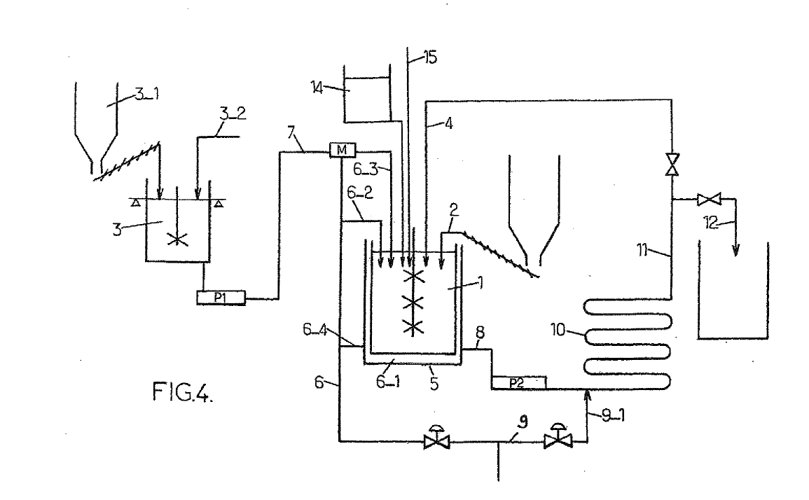

The device represented in FIG. 4 envisages the addition of one or more complementary ingredients, in liquid form (position 14—FIG. 4) or in powder form (position 15—FIG. 4).

The different useful additives can be introduced at any stage of the method according to the invention, i.e. at any point which is suitable and useful for the addition, of the device according to the invention.

For example, the introduction into one or other of the carrier fluids, into the cooking chamber itself, into the pipe conveying the glue towards a storage reservoir and/or into the storage reservoir will be chosen.

A subject of the present invention is also the use of the starchy compositions with a high content of dry matter.

In fact, the particularly useful rheological properties of the compositions according to the invention allow their use for the formulation of slips or for the formulation of adhesive compositions which are useful for very varied gluing operations such as the gluing of bags, of spiral tubes, or for labelling bottles.

The dilution of such compositions is not always desired or sought. However, taking account of their particular characteristics, they may useful, in particular for operations for finishing paper, cellulose panels, textile materials, including fibres or mineral panels, leather.

Said compositions can also be used for particular formulations of interest to the construction materials industry and the oil industry.

Their surprising characteristics allow their use in operations of interest to the pharmaceuticals industry, the cosmetics industry or the food-processing industry such as, for example, encapsulation or coating.

They can also be useful in the development of compositions intended for gluing, in particular, bags and drums or also for assembling any complex structure, in particular of cellulose.

They can in particular be useful for gluing corrugated cardboard, in particular within the context of gluing operations carried out with a low heat input on a machine (so-called “cold” gluing).

They are more commonly involved, as the primary portion, in the development of so-called two-component compositions, used in particular within the context of methods known by the names “Stein-Hall” or “Minocar” methods, for the gluing of all types of corrugated cardboard, i.e. so-called single face (SF), double face (DF), double-double (DD), triple or multi-corrugations, which may or may not comprise micro-corrugations.

The different aspects of the present invention, relating to the method and the device, as well as the characteristics of the various adhesive compositions which are accessible according to these means, will be described in more detail using the examples which follow, which are in no way limiting.

### EXAMPLE 1

The device is given the configuration in FIG. 3. The starting of the installation provides a delivery of powder starch at point 2, in the form of a corn dextrin, at a rate of 100 kg/h. In parallel, the flow rate of the water (points 11, 12 and/or 13) is 100 l/h.

The quantity of steam, supplied at 150° C. (6), is distributed via the base of the cooking chamber (6-4). It makes it possible to reach a temperature of 90° C. and to ensure said temperature during the start-up phase.

The same quality of steam, at 150° C., is supplied, via point 8, to the colloidal suspension (glue) obtained by setting an average residence time of 15 minutes in the cooking chamber.

The resultant solution passes through the coil in 4 minutes, benefiting from a counter-pressure set at approximately 5 bar and corresponding to an internal temperature of approximately 150° C.

Different recycling conditions are then ensured at point 10, such that, respectively, 10, 20 and 40 litres of solution are recycled and ensure, via point 4, the role of carrier fluid vis-à-vis the dextrin powder.

It should be noted that, within the context of a suitable setting, the supply of steam at point 6 decreases as a function of the recycling level, until it becomes low to very low.

### EXAMPLE 2

This case, illustrated by FIG. 2, corresponds to a device providing no recycling of the glue. A corn dextrin milk of Example 1, obtained starting with flow rates of starch of 473.8 kg/h and of water of 710.6 kg/h is prepared continuously. The milk, at 20° C. and 40%, which has a density of 1.184, receives a flow of 110.5 kg/h of steam (configuration 6-3) at 150.4° C. under a pressure of 5.4 bar. The glue is produced in this way at a rate of 1294.9 kg/h, at a dry matter level of 36.59% (821.1 kg/h of water+473.8 kg/h of starch).

On another side, a powder starch is introduced, which has a moisture content of 10%, at a flow rate of 920.1 kg/h (828 kg/h of dry starch+92 kg/h of water).

Starting from these conditions, powder/glue ratios of 71.05% and powder/(glue+powder) ratios of 41.54% are defined.

The cooking chamber thus receives, in the form of glue or powder, 913.1 kg/h of water and 1301.8 kg/h of starch, i.e. 2215 kg/h of glue with 58.77% dry matter, at a temperature of approximately 57.5° C.

The temperature in the cooking chamber is maintained at 90° C.

The glue produced supplies the coil receiving 241.25 kg/h of steam at 150.4° C. and 5.4 bar.

The final glue flows at approximately 2456 kg/h (1154.4 kg/h of water+1301.8 kg/h of starch), i.e. with 53% dry matter.

### EXAMPLE 3

The case disclosed in this example is illustrated by FIG. 1. It corresponds to a device providing, this time, recycling of the glue which has just been added to a carrier fluid in the form of glue originating from the preparation of a starch milk.

The flow rates of starch milk, and glue which result from this (configuration 6-3), are those of Example 2.

On the other hand, the glue produced at the outlet from the coil is no longer directed in its entirety towards the machine. A significant portion (1500 kg/h) is diverted and recycled, so as to constitute a carrier fluid for the envisaged cooking. This operation allows a significant increase in the powder starch flow rate. It is in fact increased to 1559.2 kg/h (1403.3 kg/h of dry starch+155.9 kg/h of water).

The established regimes are profoundly modified. In fact, the cooking chamber receives a mixture with 63.09% dry matter at an overall flow rate of 4354.15 kg/h (1607.1 kg/h of water+2747.05 kg/h of starch), at a temperature of 73° C. The temperature inside the chamber is 90° C.

The powder/glue and powder/(glue+powder) ratios are 55.79% and 35.81% respectively.

Then, the glue is directed towards the coil, receiving at 9, 382.1 kg/h of steam (150.4° C.-5.4 bar).

At the outlet of the coil, the flow rate is 4736.3 kg/h of glue (1989.25 kg/h of water for 2747.05 kg/h of starch) having a concentration of 58%, i.e. significantly greater than that of Example 2. As indicated, 1500 kg/h are recycled and 3236.3 kg/h are conveyed to the machine. The recycling/conveying and recycling/total glue ratios are thus approximately 46.35% and 31.67% respectively.

### EXAMPLE 4

The working conditions are those of Example 3, except that it is sought, firstly, to reach the highest concentration. It has thus been determined that the supply of starch powder, without modification of the inputs of milk, steam and recycled glue, could be taken to approximately 1950 kg/h.

On the other hand, the working conditions close to the threshold of interest have been determined approximately.

It is consequently possible to draw up the following table comparing these different profiles:

| | Low | Average | Optimum |
|---|---|---|---|
| | conditions | conditions: | conditions: |
| Slurry at 40% (kg/h) | 1184.4 | 1184.4 | 1184.4 |
| Water (kg/h) | 710.6 | 710.6 | 710.6 |
| Starch (kg/h) | 473.8 | 473.8 | 473.8 |
| density | 1.184 | 1.184 | 1.184 |
| Glue (kg/h) | 1295 | 1295 | 1295 |
| (configuration 6-3) | | | |
| Water (kg/h) | 821.2 | 821.2 | 821.2 |
| Starch (kg/h) | 473.8 | 473.8 | 473.8 |
| Concentration | 36.59% | 36.59% | 36.59% |
| Starch powder (kg/h) | 1351.6 | 1559.2 | 1950.4 |
| Water (kg/h) | 135.2 | 155.9 | 195 |
| Dry starch (kg/h) | 1216.4 | 1403.3 | 1755.4 |
| Supply to chamber (kg/h) | 4146.5 | 4354.1 | 4745.4 |
| Water (kg/h) | 1661.3 | 1607.1 | 1605.7 |
| Dry starch (kg/h) | 2485.2 | 2747 | 3139.7 |
| Concentration | 59.94% | 63.09% | 66.16% |
| Temperature | 37.9° C. | 73° C. | 69.3° C. |
| Powder/glue ratio | 48.36% | 55.79% | 69.79% |
| Powder/total ratio | 32.60% | 35.81% | 41.10% |
| Coil inlet steam (kg/h) | 542.5 | 382.1 | 427 |
| Coil outlet (kg/h) | 4689 | 4736.3 | 5172.5 |
| Water (kg/h) | 2203.8 | 1989.25 | 2032.8 |
| Dry starch (kg/h) | 2485.2 | 2747.05 | 3139.7 |
| Concentration | 53% | 58% | 60.70% |
| recycling | 1500 | 1500 | 1500 |
| Machine outlet | 3189 | 3236.3 | 3672.5 |
| Recycling/machine ratio | 47.04% | 46.35% | 40.84% |
| Recycling/total ratio | 31.99% | 31.67% | 29.00% |

For a useful flow rate, intended for the machine, varying only in fairly small proportions (from approximately 3200 to 3700 kg/h), the concentration of the glue develops, in a particularly useful range, between 53 and 60.7%.

The benefit of concentrations within this range is more particularly appreciable in the field of paper finishing, in particular when modifying the latex/starch ratios, or even eliminating the latex. For gluing corrugated cardboard, the removal of the water requires a low energy input.

### EXAMPLE 5

This example relates to the possibility of a significant reduction in the quantity of milk. In this case, the feasibility of an operation aiming to exceed 50% dry matter is verified.

In a second phase, the conditions making it possible to achieve an average objective are defined.

In a third phase, the optimum conditions leading to the highest dry matter contents are sought.

| | Low | Average | Optimum |
|---|---|---|---|
| | conditions | conditions | conditions |
| Starch powder (kg/h) | 161.9 | 324.2 | 985.8 |
| Water (kg/h) | 16.2 | 32.4 | 98.6 |
| Dry starch (kg/h) | 145.7 | 291.8 | 887.2 |
| Chamber supply (kg/h) | 1661.9 | 1824.2 | 2485.8 |
| Water (kg/h) | 721.2 | 557.4 | 473.6 |
| Dry starch (kg/h) | 940.7 | 1266.8 | 2012.2 |
| Concentration | 56.6% | 69.45% | 80.85% |
| Temperature | 93° C. | 87.2 | 70° C. |
| Powder/glue ratio | 10.79% | 21.61% | 65.72% |
| Powder/total ratio | 9.74% | 17.77% | 39.66% |
| Coil inlet steam (kg/h) | 113 | 124.7 | 197.2 |
| Coil outlet (kg/h) | 1774.9 | 1948.9 | 2683 |
| Water (kg/h) | 834.2 | 682.1 | 670.75 |
| Dry starch (kg/h) | 940.7 | 1266.8 | 2012.25 |
| Concentration | 53% | 65% | 75% |
| recycling | 1500 | 1500 | 1500 |
| Machine outlet | 274.9 | 448.9 | 1183 |
| Recycling/machine | 545.7% | 334% | 126.8% |
| ratio | | | |
| Recycling/total | 84.5% | 77% | 55.9% |
| ratio | | | |

In the three cases envisaged, it is possible to rapidly reach am equilibrium situation.

The range of possible concentrations is still wider.

It is possible to achieve 75% dry matter.

### EXAMPLE 6

This example makes it possible to consider the particular case of useful discontinuous operation, in particular, in a test period or on machines having low capacities. The objective integrates the production of a limited quantity of corn dextrin glue with 50% dry matter.

The equipment is, in this investigation, reduced to a vertical vat equipped with a powerful stirrer, for example, equipped with a Rayneri turbine and followed by a pump which supplies a tubular cooker under pressure (“Jet Cooker”). The discontinuous sequence is the following:
59 litres of water in a vertical vat of sufficient capacity,
supply of 2×25 kg bags of corn dextrin, for the preparation of a milk with 41.4% dry matter,
cooking at 90° C. for 10 minutes under vigorous stirring.

This first preparation, in the form of a colloidal solution, constitutes the carrier fluid.

In a second stage, 3×25 kg bags of the same corn dextrin are added to it. The mixture has a dry matter content equal to 56%. It is taken to 90° C. for 10 minutes. It is then subjected to the complementary cooking action, in the Jet-Cooker, at 150° C. for 3 minutes.

The glue, produced with 50.6% dry matter, is supplied to a thermally insulated vat, with a minimum capacity of 300 litres.

### EXAMPLE 7

A cooking test is carried out starting with a corn dextrin on a device according to the principle established in FIG. 2, with the configuration (6-2), in conjunction with the introduction, into the cooking chamber, of a dextrin powder on the one hand, and on the other hand, a milk with 40% dry matter, prepared from the same dextrin.

The temperature maintained in the chamber is 90° C.

The temperature in the coil is set at 150° C.

The object of this test is to carry out the investigation relating to a modest concentration and assess the result in rheological terms. To this end, the milk/powder ratio is first defined in order to obtain a glue with 38% dry matter. Then it is progressively modified in order to increase the concentration until it is greater than 50%.

In a first phase, on an apparatus of average capacity, 50% dry matter is achieved.

In a second stage, on an industrial installation, 53.5% is achieved.

The two glues are the subject of rheological assessments during a cooling stage, according to the now established and widespread principles for the determination of the viscoelastic modules G′ and G″ making it possible to determine the sol/gel conversion.

These measurements are carried out using an AR2000 dynamic rheometer, using 14/15 mm coaxial cylinders. The linear cooling gradient is comprised between 80 and 5° C., at a rate of 1° C./minute. The sinusoidal stress constraint varies as a function of the response of the sample tested. The frequency is fixed at 1 Hertz.

The fundamental observation, whether on glue obtained in a pilot plant or on that obtained on industrial equipment, resides in the absence of a sol/gel conversion phase, this fact resulting in a stability of the glues on cooling, which is quite remarkable.

In a particularly surprising and unexpected fashion, these glues, when they are diluted to 35% and even to 25% dry matter, retain this surprising characteristic.

On the other hand, glues obtained with the abovementioned dry matter contents of 35 and 25% dry matter, according to conventional cooking means, whether continuous or discontinuous, under pressure or in an open vat, have a sol/gel conversion phase, revealing the existence of a retrogradation phenomenon. For example, a glue of the same corn dextrin, prepared with 25% dry matter by cooking with live steam, exhibits a sol/gel conversion towards 61° C., the temperature at which retrogradation commences.

Moreover, the level of the viscoelastic moduli is, according to the invention, clearly below that presented according to the prior art, as well as an apparent viscosity, measured for example with a Brookfield viscosimeter, which is very substantially higher.

It is in this way that, more precisely, the dextrin glue prepared according to the invention, on an industrial device, with 53.5% dry matter, on cooling, has the following viscosities, measured with the Brookfield viscosimeter at 100 rpm (in mPa·S):

| | On fresh glue | After 24 hours at 70° C. |
|---|---|---|
| 80° C. | 1150 | |
| 70° C. | 1724 | 2690 |
| 60° C. | 2780 | 3080 |
| 50° C. | 4480 | 4170 |
| 40° C. | 6860 | 6490 |
| 30° C. | 15000 | 16200 |

It may be noted that these glues remain capable of flowing satisfactorily at the temperatures used, in particular relative to the fields of paper finishing such as surface applications or coatings, i.e. at temperatures generally comprised between 50 and 70° C.

The absence of retrogradation manifestations is moreover accompanied by a remarkable stability over time, in particular at low temperatures.

It is thus established that the compositions according to the invention have unique characteristics at the concentrations concerned.

For any person skilled in the art, these results cannot be achieved by conventional means, if only because of the impossibility, due in particular to dilatancy phenomena, of preparing starch milks with a sufficiently high level of dry extracts to hope to achieve the intended final concentrations.

Moreover, the rheological data of the glues obtained by conventional means with 35% dry matter, for example, are such that the foreseeable viscosities at high concentrations would be so high that they could not be measured under the same measurement conditions, thus expressing the absolute impossibility of using the glues.

### EXAMPLE 8

The working conditions are similar to those of Example 7, with a device according to FIG. 2 and the configuration 6-2, with the essential difference that the protocol is applied not only to the cooking of the corn dextrin but to an operation of solubilization and of enzymatic hydrolysis of a native corn starch. In this case, the solubilization and enzymatic hydrolysis chamber is maintained at 85° C.

The temperature in the coil, which is now inhibiting the enzymatic activity is 150° C.;

As in Example 7, the milk/powder ratio is fixed such that the dry matter in the liquefied glue obtained is 38% in a first phase. The ratio is then modified so that the dry matter increases progressively until it exceeds 50%.

If the operating context is different, the observations made, in the present case, on a glue with 52% dry matter, are completely comparable. As in Example 7, when the AR2000 dynamic rheometer and coaxial cylinders are used, under the conditions previously defined for the cooling gradient, the absence of sol/gel conversion and, as a result, the absence of any retrogradation phenomenon within the range of the temperatures considered is noted.

Under conditions comparable to those of Example 7, measurements of viscosities on cooling (in mPa·s, at 100 rpm) are also carried out:

| | On fresh glue | After 24 hours at 70° C. |
|---|---|---|
| 80° C. | 840 | |
| 70° C. | 952 | 1244 |
| 60° C. | 1228 | 1340 |
| 50° C. | 1504 | 1624 |
| 40° C. | 2160 | 2304 |
| 30° C. | 3020 | 2868 |

It is possible to repeat the conclusion reached in Example 6 as regards all its points, whether in terms of the absence of sol/gel conversion on a AR2000 rheometer, or in the concentrated form, close to or above 50% or diluted to 35%, or even 25%, flowability at the operating temperatures, in particular for surface application or coating, or of the absence of retrogradation manifestations and stability over time, in particular, at low temperatures.

The rheological characteristics at the concentrations concerned are incomparable, it being understood in particular that glues which have such dry extracts cannot be prepared by conventional means. Their viscosities would be much too high and, consequently, not measurable and unusable.

1. Method for cooking a starchy composition comprising:
(a) a first stage comprising the mixing of at least one starch powder with an aqueous starch slurry containing granular starch and/or gelatinized starch, the starch content of the aqueous starch slurry and the mixing ratio of the starch powder to the aqueous starch slurry being such that the total starch content of the mixture obtained is greater than 45% by weight, preferably comprised between 50 and 82% by weight, and in particular comprised between 52% and 75% by weight, said first stage being carried out at atmospheric pressure, under stirring, in a cooking chamber maintained at a temperature at least equal to the highest gelatinization temperature (TG) of all of the starches present in the mixture for a time which is sufficient to obtain a colloidal solution of starch, and
(b) a second stage comprising the heating of the colloidal solution of starch obtained in stage (a), at a pressure above atmospheric pressure and at a temperature comprised between 120° C. and 180° C., preferably comprised between 140° C. and 180° C. for a period sufficient to destroy the intermolecular hydrogen bonds and avoid retrogradation of the starch solution obtained.

2. Method according to claim 1, characterized in that the first stage (stage (a)) is carried out at a temperature at least 5° C., preferably at least 10° C., above the highest gelatinization temperature of all of the starches present in the mixture.

3. Method according to claim 1, characterized by the fact that the duration of the first stage is comprised between 3 minutes and 2 hours, preferably between 5 minutes and 1 hour, and in particular between 10 and 30 minutes.

4. Method according to claim 1, characterized by the fact that the duration of heating at stage (b) is sufficient to obtain starch solutions essentially free from granular starch.

5. Method according to claim 1, characterized by the fact that the duration of heating at stage (b) is sufficient to obtain starch solutions having a Brookfield viscosity, measured at 25° C., of less than 6000 centipoises, preferably less than 5000 centipoises and in particular less than 4000 centipoises.

6. Method according to claim 1, characterized in that the duration of heating at stage (b) is comprised between 15 seconds and 30 minutes, preferably between 20 seconds and 15 minutes and in particular between 30 seconds and 10 minutes.

7. Method according to claim 1, characterized in that the heating at stage (b) is carried out by the injection of steam under pressure into the colloidal starch solution obtained at the end of stage (a).

8. Method according to claim 1, characterized in that the aqueous starch slurry, before being introduced into the cooking chamber of stage (a), is heated to a temperature comprised between 100° C. and 180° C.

9. Method according to claim 1, characterized in that the starch powder introduced into the cooking chamber of stage (a) has a moisture content of less than 50%, preferably comprised between 3 and 30%, in particular comprised between 7 and 22%.

10. Method according to claim 1, characterized in that the aqueous starch slurry is a starch milk having a dry matter content of less than 52%, preferably comprised between 20 and 50%, in particular comprised between 30 and 45% by weight.

11. Method according to claim 1, characterized in that the aqueous starch slurry is a colloidal solution of starch having a starch content of less than 75%, preferably comprised between 35 and 70%, and in particular comprised between 38 and 65% by weight.

12. Method according to claim 1, characterized by the fact that the starch powder and the starch in the aqueous starch slurry are chosen independently from the starches of tubers, the starches of cereals and the starches of legumes, optionally modified.

13. Method according to claim 1, characterized in that the starch powder and the starch in the aqueous starch slurry are of the same origin.

14. Method according to claim 1, characterized by the fact that part of the starch solution obtained at the end of stage (b) is recycled to stage (a) in order to serve as aqueous starch slurry.

15. Starch composition obtainable by a method according to claim 1.

16. Starch composition according to claim 15, characterized by the fact that it has a total starch content of less than 75%, preferably comprised between 35 and 70%, and in particular comprised between 38 and 65% by weight.

17. Starch composition according to claim 15, characterized by the fact that it has a Brookfield viscosity, measured at 25° C., of less than 6000 centipoises, preferably less than 5000 centipoises and in particular less than 4000 centipoises.

18. Starch composition according to claim 15, characterized by the fact that it is essentially free of granular starch.

19-20. (canceled)
